(19) United States
(12) Patent Application Publication
(10) Pub. No.: US 2023/0183040 A1
(43) Pub. Date: Jun. 15, 2023

(54) SOLUTION FOR MANAGING USAGE DATA OF AN ELEVATOR SYSTEM OPERATING IN A CONSTRUCTION TIME USE MODE

(71) Applicant: KONE CORPORATION, Helsinki (FI)

(72) Inventors: Markku Haapaniemi, Helsinki (FI); Matti Räsänen, Helsinki (FI); Aki Haikonen, Helsinki (FI); Anssi Venho, Helsinki (FI); Jari Kantola, Helsinki (FI)

(73) Assignee: KONE CORPORATION, Helsinki (FI)

(21) Appl. No.: 18/105,403

(22) Filed: Feb. 3, 2023

Related U.S. Application Data
(63) Continuation of application No. PCT/FI2020/050565, filed on Sep. 1, 2020.

(51) Int. Cl. B66B 5/00; B66B 1/34; B66B 1/06

(52) U.S. Cl. CPC B66B 5/0018; B66B 1/3461; B66B 1/06

(57) ABSTRACT

The invention relates to a method for managing usage data of an elevator system (100) operating in a construction time use (CTU) mode. The method comprises: operating (210) the elevator system (100) in the CTU mode, obtaining (220) statistical usage data of the elevator system (100), comparing (230) the obtained statistical usage data to reference data, detecting (240) that the obtained statistical usage data deviates at least partly from the reference data, and generating (250) at least one control signal comprising an indication of the detected deviation to at least one operator system (114) in response to the detection of the deviation. The invention relates also to a computing unit (112) and an elevator system (100) for managing usage data of an elevator system (100),

### TECHNICAL FIELD

The invention concerns in general the technical field of elevator systems. Especially the invention concerns elevator systems operating in a construction time use mode.

### BACKGROUND

Typically, an elevator system comprises systems and/or devices for providing and collecting usage data of the elevator system during a normal operation of the elevator system. The normal operation in this context means operation of the elevator system in a finished, i.e. completed, building. In other words, in the normal operation the elevator system serves end-users of the finished building. The usage data may be important for an operator of the elevator system and/or an operator of the building, e.g. a facility manager of the building.

A construction time use (CTU) of the elevator systems is constantly increasing. Thus, there may also be need for providing and collecting usage data of the elevator system during the construction time use of the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a computing unit, and an elevator system for managing usage data of an elevator system operating in a construction time use (CTU) mode. Another objective of the invention is that the method, the computing unit, and the elevator system for managing usage data of an elevator system operating in a construction time use (CTU) mode enable providing usage data of an elevator system operating in a construction time use (CTU) mode.

The objectives of the invention are reached by a method, a computing unit, and an elevator system as defined by the respective independent claims.

According to a first aspect, a method for managing usage data of an elevator system operating in a construction time use (CTU) mode is provided, wherein the method comprises: operating the elevator system in the CTU mode, obtaining statistical usage data of the elevator system, comparing the obtained statistical usage data to reference data, detecting that the obtained statistical usage data deviates at least partly from the reference data, and generating at least one control signal comprising an indication of the detected deviation to at least one operator system in response to the detection of the deviation.

The reference data may be predefined, dynamically adjusted, or defined based on previously obtained statistical usage data.

The step of detecting the deviation may comprise detecting that the obtained statistical usage data deviates from the reference data at least by a predefined difference value.

The statistical usage data may comprise at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

The at least one control signal may further comprise at least one recommended action that depends on the obtained statistical usage data.

The statistical usage data of the elevator system may be obtained from an elevator control unit of the elevator system and/or a separate unit.

The at least one operator system may comprise an operator system of the elevator system, an operator system of a construction site comprising the elevator system, and/or an operator system of a building.

According to a second aspect, a computing unit for managing usage data of an elevator system is provided, wherein the elevator system is configured to operate in a construction time use (CTU) mode, wherein the computing unit comprises: a processing unit, and a memory unit storing at least one portion of computer program code, wherein the processing unit being configured to cause the computing unit at least to perform: obtain statistical usage data of the elevator system, compare the obtained statistical usage data to a reference data, detect that the obtained statistical usage data deviates from the reference data, and generate at least one control signal comprising an indication of the detected deviation to at least one operator system in response to the detection of the deviation.

The reference data may be predefined, dynamically adjusted, or defined based on previously obtained statistical usage data.

The detection of the deviation may comprise detecting that the obtained statistical usage data deviates from the reference data at least by a predefined difference value.

The statistical usage data may comprise at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

The at least one control signal may further comprise at least one recommended action that depends on the obtained statistical usage data.

The statistical usage data of the elevator system may be obtained from an elevator control unit of the elevator system and/or a separate unit.

The at least one operator system may comprise an operator system of the elevator system, an operator system of a construction site comprising the elevator system, and/or an operator system of a building.

According to a third aspect, an elevator system for managing usage data of the elevator system is provided, wherein the elevator system is configured to operate in a construction time use (CTU) mode, wherein the elevator system comprises: at least one operator system, and a computing unit described above, wherein the computing unit and the at least one operator system are communicatively coupled with each other.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIGS. 1A-1C illustrate schematically examples of an elevator system according to the invention.

FIG. 2 illustrates schematically an example of a method according to the invention.

FIG. 3 illustrates schematically another example of an elevator system according to the invention.

FIG. 4 illustrates schematically an example of entities of a computing unit according to the invention.

### DESCRIPTION OF THE EXEMPLIFYING EMBODIMENTS

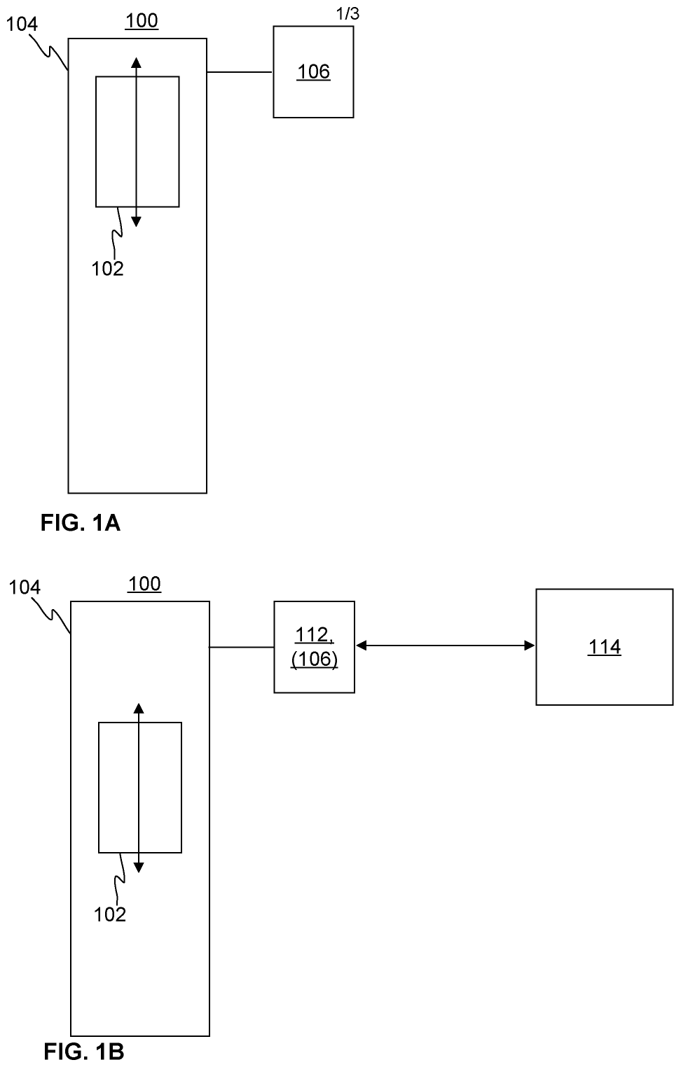

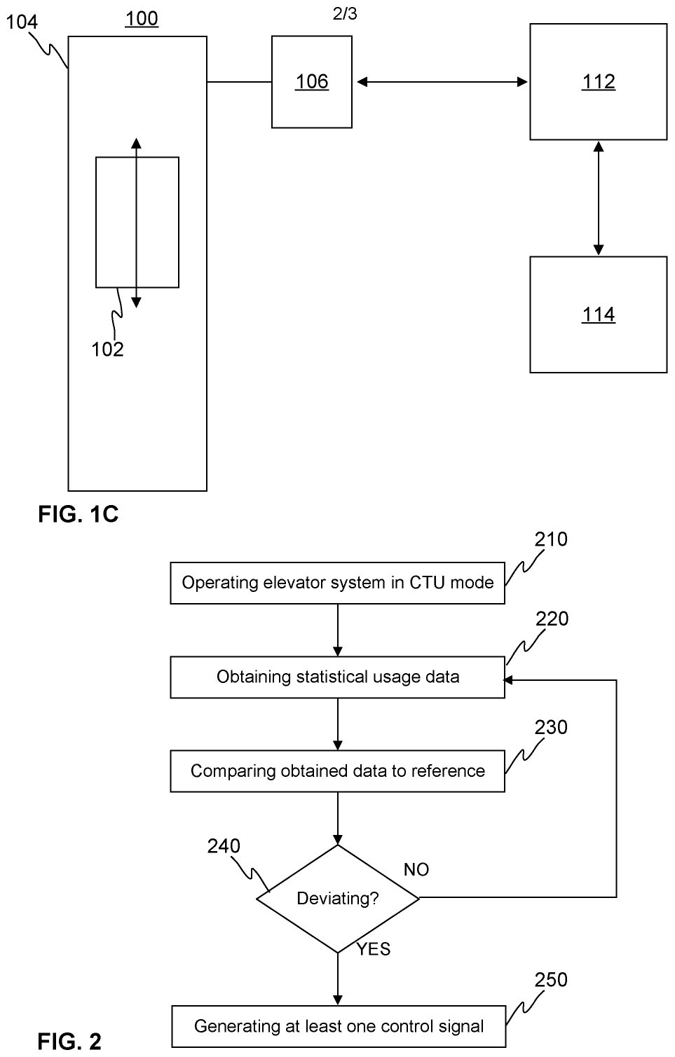

FIG. 1A illustrates schematically a simple example of an elevator system 100 in which different embodiments of the present invention may be implemented. The elevator system 100 may comprise at least one elevator car 102 travelling along respective at least one elevator shaft 104 between a plurality of floor, i.e. landings, an elevator control unit 106, and a hoisting machine configured to drive the at least one elevator car 102 along the respective elevator shaft 104 between the landings. For sake of clarity the hoisting machine is not illustrated in FIGS. 1A-1C. The elevator system 100 may further comprise one or more other elevator related entities, e.g. elevator user interface devices, drive circuit and devices, safety circuit and devices, sensors, elevator door circuits and devices, etc. The elevator control unit 106 may be configured to control the operations of the elevator system 100. The implementation of the elevator control unit 106 may be done as a stand-alone control entity or as a distributed control environment between a plurality of stand-alone control entities providing distributed control resource. The elevator control unit 106 may be communicatively coupled to one or more entities of the elevator system 100. The communication between the elevator control unit 106 and the one or more entities of the elevator system 100 may be based on at least one known communication technologies, either wired or wireless. The elevator control unit 106 may locate in a machine room of the elevator system 100 or in one of the landings of the elevator system 100.

The elevator system 100 according to the invention locates in a building, which is under construction. In other words, the elevator system 100 according to the invention is configured to operate in a construction time use (CTU) mode. The elevator system 100 may be configured to operate in the CTU mode during the construction of the building. In the CTU mode the elevator system 100 may be configured to transport and/or serve people, e.g. construction workers, and/or material, e.g. construction material, during the construction. After completion of the construction project of the building, the elevator system 100 may be converted into a final permanent elevator system of the building and configured to operate in a normal operation mode. The normal operation of an elevator system is used in this patent application to mean operation of the elevator system in a finished, i.e. completed, building to serve end-users of the finished building.

FIGS. 1B and 10 illustrate schematically other examples of the elevator system 100 according to the invention. The elevator system 100 comprises further a computing unit 112 and at least one operator system 114. The computing unit 112 may be e.g. the elevator control unit 106, a local computing unit residing inside the building, or an external computing unit, e.g. a cloud server, residing outside the building. Alternatively, in case the elevator system 100 comprises an elevator group, the computing unit 112 may be an elevator group control unit or an elevator control unit operating as the elevator group control unit. The term “elevator group” is used in this patent application to mean a group of two or more elevators, i.e. group of two or more elevator cars 102 travelling along respective elevator shafts 104, wherein the elevator shafts 104 are arranged either adjacent or opposite one another, and wherein the elevator group is operating as a unit serving the same floors. In the example of FIG. 1B the computing unit 112 is the elevator control unit 106 of the elevator system 100. In the example of FIG. 10 the computing unit 112 is a local computing unit residing inside the building or an external computing unit residing outside the building. The computing unit 112 implemented as the local computing unit or the external computing unit may be communicatively coupled to the elevator control unit 106. The communication between the computing unit 112 implemented as the local computing unit or the external computing unit and the elevator control unit 106 may be based on at least one known communication technologies, either wired or wireless. Some non-limiting examples of the local computing unit may e.g. be a server, a personal computer, a laptop computer, a computing circuit, or a network of computing devices. The at least one operator system 114 may comprise an operator system of the elevator system 100, an operator system of a construction site comprising the elevator system 100, and/or an operator system of the building e.g. a facility manager of the building. The computing unit 112 and the at least one operator system 114 may be communicatively coupled with each other. The communication between the computing unit 112 and the at least one operator system 114 may be based on at least one known communication technologies, either wired or wireless.

FIG. 2 illustrates schematically an example of a method according to the invention for managing usage data of the elevator system 100 operating in the CTU mode. At a step 210, the elevator system 100 is operating in the CTU mode. Although operating the elevator system 100 in the CTU mode is illustrated with a separate method step 210 in FIG. 2, the elevator system 100 is operating in the CTU mode during all steps of the method according to the invention, i.e. steps 210-250.

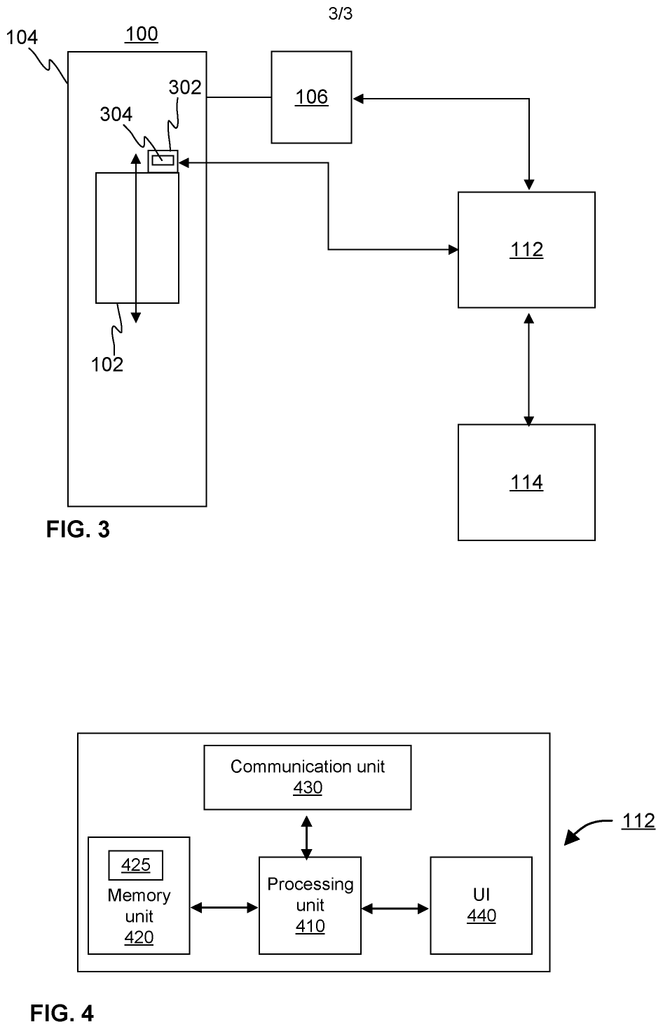

At a step 220, the computing unit 112 obtains statistical usage data of the elevator system 100. The statistical usage data may be obtained from the elevator control unit 106 and/or from a separate unit 302. If the computing unit 112 is the elevator control unit 106, the elevator control unit 106 may itself provide the statistical usage data of the elevator system 106 and/or obtain the statistical usage data from the separate unit 302. FIG. 3 illustrates schematically another example of the elevator system 100 according to the invention, wherein the computing unit 112 is implemented as a local computing unit or an external computing unit. In the example of FIG. 3 the computing unit 112 may obtain the statistical usage data from the separate unit 302. Alternatively or in addition, in the example of FIG. 3 the computing unit 112 may obtain the statistical usage data from the elevator control unit 106. The separate unit 302 may be arranged to the at least one elevator car 102 of the elevator system 100, e.g. to a rooftop of the elevator car 102 as illustrated in the example of FIG. 3. The separate unit 302 may comprise one or more sensor devices 304 configured to provide the statistical usage data of the elevator system 100. The one or more sensor devices 304 may be external devices to the separate unit 302 and/or internal devices of the separate unit 302. In the example of FIG. 3 the one or more sensor devices 304 are internal devices of the separate unit 302. The statistical usage data may comprise a number of departures of the at least one elevator car 102 during a predefined period of time. Alternatively or in addition, the statistical usage data may comprise a number of departures of the at least one elevator car 102 from each departure floor during a predefined period of time. Alternatively or in addition, the statistical usage data may comprise a number of arrivals of the at least one elevator car 102 to each destination floor during a predefined period of time. Alternatively or in addition, the statistical usage data may comprise a weight of a load of the at least one elevator car 102 at the departure of the at least one elevator car 102. Alternatively or in addition, the statistical usage data may comprise a response time, i.e. waiting time, of an elevator call, i.e. time passed from a generation of the elevator call to the arrival of the elevator car 102. The predefined period of time may be, but is not limited to, 1 hour, 1 day, 1 week, etc. Alternatively or in addition, the predefined period of time may depend on the obtained statistical usage data, i.e. the predefined period of time may be different for different statistical usage data.

At a step 230, the computing unit 112 compares the obtained statistical usage data to reference data. The reference data may be predefined, dynamically adjusted, or defined based on previously obtained statistical usage data. The reference data may be a single reference value or a range of reference values. Alternatively or in addition, the reference data may be dependent on the obtained statistical usage data. In other words, the obtained statistical usage data of the elevator system 100 is compared to respective reference data. For example the obtained number of departures of the at least one elevator car 102 during the predefined period of time may be compared to a reference value or a reference range of values representing number of departures of the at least one elevator car 102 during the predefined period of time.

At a step 240, the computing unit 112 detects that the obtained statistical usage data deviates from the reference data at least partly. Depending on the obtained statistical usage data the deviation may be exceeding the reference data, meeting the reference data, or being less than the reference data. The term “meet” in the context of the reference data is used in this patent application to mean that a predefined condition is fulfilled. For example, the predefined condition may be that the reference data is reached and/or exceed. The step of detecting the deviation may comprise detecting that the obtained statistical usage data deviates from the reference data at least by a predefined difference value. The predefined difference value may for example be dependent on the obtained statistical usage data.

At a step 250, the computing unit 112 generates at least one control signal to the at least one operator system 114 in response to the detection of the deviation at the step 240. The at least one control signal may comprise an indication of the detected deviation. The at least one control signal may further comprise at least one recommended action that depends on the obtained statistical usage data. The at least one recommended action may be e.g. a maintenance action, at least one instruction to one or more users of the elevator system, and/or load related action.

According to an a non-limiting example case, wherein the statistical usage data comprises the number of departures of the at least one elevator car 102 during the predefined period of time, e.g. the number of departures per 1 hour, and the computing unit 112 detects that the obtained number of departures of the at least one elevator car 102 exceeds the respective reference data, e.g. reference number of departures per 1 hour. In response to the detection of the deviation the computing unit 112 may generate the at least one control signal to the at least one operator system 114, wherein the at least one control signal may comprise at least one maintenance action, e.g. a need for maintenance of the at least one elevator car 102.

According to another non-limiting example case, wherein the statistical usage data comprises the number of departures of the at least one elevator car 102 from each departure floor during the predefined period of time, e.g. the number of departures per 1 week, and the computing unit 112 detects that the obtained number of departures of the at least one elevator car 102 from at least one departure floor exceeds the respective reference data, e.g. reference number of departures per 1 week. In response to the detection of the deviation the computing unit 112 may generate the at least one control signal to the at least one operator system 114, wherein the at least one control signal may comprise at least one maintenance action, e.g. a need for maintenance at said at least one departure floor and/or condition inspection at said at least one departure floor.

According to another non-limiting example case, wherein the statistical usage data comprises the number of arrivals of the at least one elevator car 102 from each destination floor during the predefined period of time, e.g. the number of arrivals per 1 week, and the computing unit 112 detects that the obtained number of arrivals of the at least one elevator car 102 from at least one destination floor exceeds the respective reference data, e.g. reference number of arrivals per 1 week. In response to the detection of the deviation the computing unit 112 may generate the at least one control signal to the at least one operator system 114, wherein the at least one control signal may comprise at least one maintenance action, e.g. a need for maintenance at said at least one destination floor and/or condition inspection at said at least one destination floor.

According to another non-limiting example case, wherein the statistical usage data comprises weight of the load of the at least one elevator car 102 at the departure of the at least one elevator car 102, and the computing unit 112 detects that the obtained weight of the load in the at least one elevator car 102 at the departure of the at least one elevator car 102 is less than the respective reference data, e.g. a reference weight. In response to the detection of the deviation the computing unit 112 may generate the at least one control signal to the at least one operator system 114, e.g. to the operator of the construction site, wherein the at least one control signal may comprise at least one load related action, e.g. a notification of missing material and/or need of more material. For example, if the load comprises material, e.g. construction material, to be transported to a specific destination floor and the computing unit 112 detects that the weight of the load is less than the reference weight, e.g. expected weight of the material to be transported, it indicates that at least some material may be missing and more material may be needed.

According to another non-limiting example case, wherein the statistical usage data comprises the response time of an elevator call, and the computing unit 112 detects that the obtained response time exceeds the respective reference data, e.g. a reference response time. In response to the detection of the deviation the computing unit 112 may generate the at least one control signal to the at least one operator system 114, e.g. to the operator of the construction site, wherein the at least one control signal may comprise at least one instruction to one or more users of the elevator system, e.g. construction workers. The at least one instruction may comprise e.g. instructions to adapt a schedule and/or a route of the one or more users.

FIG. 4 illustrates schematically an example of the entities of the computing unit 112 according to the invention. The computing unit 112 may comprise a processing unit 410 comprising one or more processors, a memory unit 420 comprising one or more memories, a communication unit 430 comprising one or more communication devices, and possibly a user interface (UI) unit 440. The mentioned elements of may be communicatively coupled to each other with e.g. an internal bus. The one or more processors of the processing unit 410 may be any suitable processor for processing information and control the operation of the computing unit 112, among other tasks. The memory unit 420 may store portions of computer program 425, the obtained statistical usage data, the reference data, and any other data, and the processing unit 410 may cause the computing unit 112 at least to implement one or more method steps and/or operations of the computing unit 112 as described above by executing at least some portions of the computer program 425 stored in the memory unit 420. Furthermore, the one or more memories of the memory unit 420 may be volatile or non-volatile. Moreover, the one or more memories are not limited to a certain type of memory only, but any memory type suitable for storing the described pieces of information may be applied in the context of the invention. The communication unit 430 may be based on at least one known communication technologies, either wired or wireless, in order to exchange pieces of information as described earlier. The communication unit 430 provides an interface for communication with any external unit, such as the at least one operator system 114, the elevator control system 106, the separate unit 302, database and/or any other external systems. The communication unit 430 may comprise one or more communication devices, e.g. radio transceiver, antenna, etc. The user interface 440 may comprise I/O devices, such as buttons, keyboard, touch screen, microphone, loudspeaker, display and so on, for receiving input and outputting information.

The specific examples provided in the description given above should not be construed as limiting the applicability and/or the interpretation of the appended claims. Lists and groups of examples provided in the description given above are not exhaustive unless otherwise explicitly stated.

1. A method for managing usage data of an elevator system operating in a construction time use mode, the method comprising:
operating the elevator system in the CTU mode,
obtaining statistical usage data of the elevator system,
comparing the obtained statistical usage data to reference data,
detecting that the obtained statistical usage data deviates at least partly from the reference data, and
generating at least one control signal comprising an indication of the detected deviation to at least one operator system in response to the detection of the deviation.

2. The method according to claim 1, wherein the reference data is predefined, dynamically adjusted, or defined based on previously obtained statistical usage data.

3. The method according to claim 1, wherein the step of detecting the deviation comprises detecting that the obtained statistical usage data deviates from the reference data at least by a predefined difference value.

4. The method according to claim 1, wherein the statistical usage data comprises at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

5. The method according to claim 1, wherein the at least one control signal further comprises at least one recommended action that depends on the obtained statistical usage data.

6. The method according to claim 1, wherein the statistical usage data of the elevator system is obtained from an elevator control unit of the elevator system and/or a separate unit.

7. The method according to claim 1, wherein the at least one operator system comprises an operator system of the elevator system, an operator system of a construction site comprising the elevator system, and/or an operator system of a building.

8. A computing unit for managing usage data of an elevator system, wherein the elevator system is configured to operate in a construction time use mode, the computing unit comprises:
a processing unit, and
a memory unit storing at least one portion of computer program code,
wherein the processing unit being configured to cause the computing unit at least to perform:
obtain statistical usage data of the elevator system,
compare the obtained statistical usage data to a reference data,
detect that the obtained statistical usage data deviates from the reference data, and
generate at least one control signal comprising an indication of the detected deviation to at least one operator system in response to the detection of the deviation.

9. The computing unit according to claim 8, wherein the reference data is predefined, dynamically adjusted, or defined based on previously obtained statistical usage data.

10. The computing unit according to claim 8, wherein the detection of the deviation comprises detecting that the obtained statistical usage data deviates from the reference data at least by a predefined difference value.

11. The computing unit according to claim 8, wherein the statistical usage data comprises at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

12. The computing unit according to claim 8, wherein the at least one control signal further comprises at least one recommended action that depends on the obtained statistical usage data.

13. The computing unit according to claim 8, wherein the statistical usage data of the elevator system is obtained from an elevator control unit of the elevator system and/or a separate unit.

14. The computing unit according to claim 8, wherein the at least one operator system comprises an operator system of the elevator system, an operator system of a construction site comprising the elevator system, and/or an operator system of a building.

15. An elevator system for managing usage data of the elevator system, wherein the elevator system is configured to operate in a construction time use mode, the elevator system comprising:
at least one operator system, and
a computing unit according to claim 8,
wherein the computing unit and the at least one operator system are communicatively coupled with each other.

16. The method according to claim 2, wherein the step of detecting the deviation comprises detecting that the obtained statistical usage data deviates from the reference data at least by a predefined difference value.

17. The method according to claim 2, wherein the statistical usage data comprises at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

18. The method according to claim 3, wherein the statistical usage data comprises at least one of: a number of departures of at least one elevator car during a predefined period of time, a number of departures of at least one elevator car from each departure floors during a predefined period of time, a number of arrivals of at least one elevator car to each destination floors during a predefined period of time, a weight of a load of at least one elevator car at the departure of said elevator car, and/or a response time of an elevator call.

19. The method according to claim 2, wherein the at least one control signal further comprises at least one recommended action that depends on the obtained statistical usage data.

20. The method according to claim 3, wherein the at least one control signal further comprises at least one recommended action that depends on the obtained statistical usage data.
